(19) United States
(12) Patent Application Publication
(10) Pub. No.: US 2019/0098123 A1
(43) Pub. Date: Mar. 28, 2019

(54) CONTACT INFORMATION DISCOVERY

(71) Applicant: Vishal GUPTA, Delhi (IN)

(72) Inventor: Vishal GUPTA, Delhi (IN)

(21) Appl. No.: 15/527,021

(22) PCT Filed: Nov. 29, 2015
(86) PCT No.: PCT/IN2015/050179

§ 371 Date: May 30, 2017

Related U.S. Application Data
(60) Provisional application No. 62/085,533, filed on Nov. 29, 2014.

(51) Int. Cl. H04M 1/2745; H04M 3/42; H04M 1/57

(52) U.S. Cl. CPC H04M 1/274516; H04M 2250/60; H04M 1/57; H04M 3/42059

(57) ABSTRACT

The present invention relates to a contact information discovery method and device for automatically sharing contact information, comprising the steps of receiving a call on a first mobile device, wherein information associated with the call comprises a caller contact identifier, initiating searching of the caller contact identifier in communication log of the first mobile device and performing predetermined analyses, presenting one or more options for selection, on at least one of the first mobile device and a second mobile device, based on the predetermined analyses and exchanging predetermined set of information associated with the at least one of the presented option, with the second mobile device.

### FIELD OF THE INVENTION

The present invention relates to the field of mobile telecommunication. More particularly, relates to a method and device for exchanging contact book information, such as contact information between two or more parties involved during telephonic communication.

### BACKGROUND OF THE INVENTION

A mobile device is a telephonic communication device which permits voice calls based on mobile telephony. As is well known, in mobile telephony, base stations are provided covering corresponding cells, and a mobile device typically has a first/last hop communication with one of the base stations. Mobile telephony is implemented using standards such as GSM and CDMA (and other evolving standards such as W-CDMA/UMTS, LTE etc.).

Mobile devices store different types of information. As used in the present application, information represents data (as opposed to executable instructions), and include information types such as address book (having phone numbers and names of various people of interest), call logs (providing details of missed calls, received calls and dialed calls), and SMS logs (received SMS messages, sent SMS messages, not-yet-delivered messages, etc.). This information (address book, call logs and SMS logs) is saved at a centralized database server for tracking the account details for billing purposes. Further, there are few simple technologies like true caller or other missed call services where stored contact information is served to the recipient of the call. It however have privacy issues and therefore only a limited set of information can be provided to the call recipient and leaves the contact addition incomplete. This limited set of contact information is provided to any caller/recipients who are using this service, there is no logic to determine whether this information should be or should not be presented to the recipient/caller.

Therefore there is a need for a method and device which overcome above-mentioned problem by providing complete set of contact information to the caller/recipient based on logically determined process.

### SUMMARY OF THE INVENTION

An object of the present invention is to provide a contact information discovery method for automatically sharing contact information, comprising the steps of receiving a call on a first mobile device, wherein information associated with the call comprises a caller contact identifier, initiating searching of the caller contact identifier in communication log of the first mobile device and to perform predetermined analysis, presenting one or more options for selection, on at least one of the first mobile device and a second mobile device, based on the predetermined analysis and exchanging predetermined set of information associated with the at least one of the presented option, with the second mobile device.

A another object of the present invention is to provide A contact information discovery method for automatically sharing contact information, comprising the steps of receiving a call using a mobile network at a first mobile device, wherein information associated with the call comprises a caller contact identifier, initiating searching of the caller contact identifier in a call log of first mobile device and performing predetermined call log analysis, presenting one or more options for selection, on at least one of the first mobile device and a second mobile device, based on the call log analysis and transmitting predetermined set of the contact information associated with at least one of the presented option, using a mobile network to the second mobile device.

A furthermore object of the present invention is to provide a machine readable medium carrying one or more sequences of instructions for execution by one or more processors in a device accessible by a network interface based on cellular telephony for enabling remote access to information stored on a first mobile device, wherein execution of said one or more sequences of instructions by said one or more processors causes said device to perform the actions of: receiving a call using a mobile network from first mobile device, wherein the incoming call comprises a caller contact identifier; initiating searching of the incoming call contact identifier in calls log history associated with a second mobile device and performing predetermined communication log analysis; presenting one or more options for selection, on at least one of the first mobile device and a second mobile device, based on call log pattern analysis; and transmitting predetermined set of the contact information associated with at least one of the presented option using the mobile network to the at least one of the first mobile device and second mobile device.

A furthermore object of the present invention is to provide contact discovery and sharing apparatus where two people in a telecom connection are identified that are related to each other and then presented options to retrieve each other's contact details automatically.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 shows a simplified block diagram of contact information discovery system (100) architecture in accordance with an embodiment of the present invention.

FIG. 2 shows an example of a contact information discovery device of FIG. 1 in accordance with an embodiment of the present invention;

FIG. 3 illustrates an example of contact information discovery and sharing device by way of a pseudo-flow block diagram according to an embodiment of the present invention;

FIG. 4 illustrates a block diagram illustrating an exemplary architecture of the discovery server 400 in one embodiment; and

FIG. 5 illustrates flow diagram illustrating an example of contact information sharing between caller and recipient according to an embodiment of the present invention.

FIG. 6 illustrates flow chart illustrating an example of contact information discovery between caller and recipient according to an embodiment of the present invention.

### DETAILED DESCRIPTION OF THE PREFERRED EMBODIMENTS

Throughout the following discussion, numerous references will be made regarding servers, services, interfaces, engines, modules, clients, peers, portals, platforms, or other systems formed from mobile devices. It should be appreciated that the use of such terms is deemed to represent one or more mobile devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

The terms “configured to” and “programmed to” in the context of a processor refer to being programmed by a set of software instructions to perform a function or set of functions.

One should appreciate that the disclosed contacts directory discovery system provides numerous advantageous technical effects. For example, the contacts directory discovery system of some embodiments enables up-to-date contact information by methodically allowing the persons to update and edit contacts and contact information in shared directories.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

Methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the described concepts and does not pose a limitation on the scope of the disclosure. No language in the specification should be construed as indicating any non-claimed essential component.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

This disclosure allows for construction or configuration of a mobile system or device to operate on vast quantities of digital data, beyond the capabilities of a human. The mobile system or device is able to manage the digital data in a manner that could provide utility to a user of the mobile system or device that the user would lack without such a tool.

The present invention will now be described in detail with reference to the accompanying drawings.

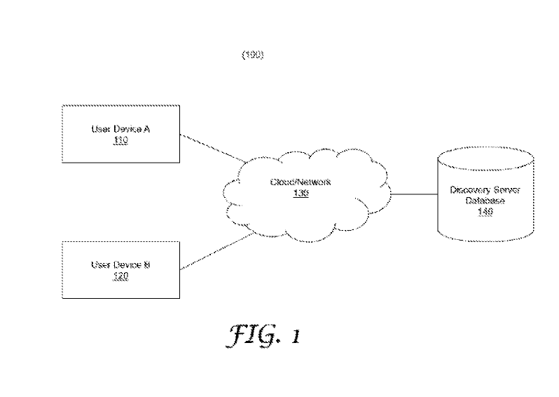

FIG. 1 shows a simplified block diagram of system (100) architecture in accordance with an embodiment of the present invention. The system 100 includes two mobile devices 110, 120, a network 130 and discovery server database 140 for processing user communication log for presenting information during the incoming call. Although two user mobile devices 110, 120 are illustrated for purpose of the following discussion, the techniques of the present disclosure are not limited to two mobile devices (e.g., user mobile devices 110, 120), and apply generally to multiple mobile devices, as will become apparent from the following discussions. For example one or more mobile device established conference call to other users.

Network 130 represents one or more networks used for communication between user mobile devices 110, 120 and discovery server 140. Such networks include public and private networks, static and ad hoc networks, wired and wireless networks, wide area networks (WANs), local-area networks (LANs), personal-area networks (PANs), cellular networks, satellite networks, and other networks. Communication between user mobile devices 110, 120 and discovery server 140 may cross multiple networks. User mobile devices 110, 120 and discovery server 140 each may include capability to communicate across one or more networks, using the associated standard or proprietary protocol(s) of the network(s). For example, user mobile device 110 may include Wi-Fi communication capability for communication by way of a router to an Internet connection to discovery server 140, whereas user mobile device 120 may include cellular communication capability for communication by way of a mobile network to an Internet connection to discovery server 140. Many other networking configurations are also possible, and are within the scope of the present disclosure.

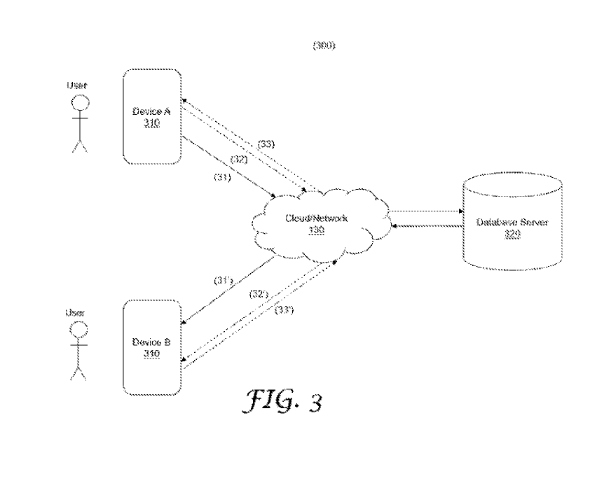

When a user device 110 dial a number of another user device 120 and establishes a call over telephone network. The discovery server 140 determines whether the device 110, 120 has any relatedness with each other based on the previous communication between them. Based on this analysis discovery server presents one or more user selectable option to one or both devices 110, 120 screen for further initiating exchange of stored contact information. This entire analysis is executed by server 140 of the call between user devices 110, 120. More detail is provided with respect to FIG. 3.

User mobile devices 110, 120 and discovery server 140 are examples of mobile devices generally, which include hardware, firmware, software, or a combination thereof, and implement a desired functionality by the execution of instructions. Examples of mobile devices include, but are not limited to, a mobile phone, a smart phone, smart watch, a personal digital assistant (PDA), tablet computers, notebook computers, laptop computers, desktop computers, or other similar portable having communication capability.

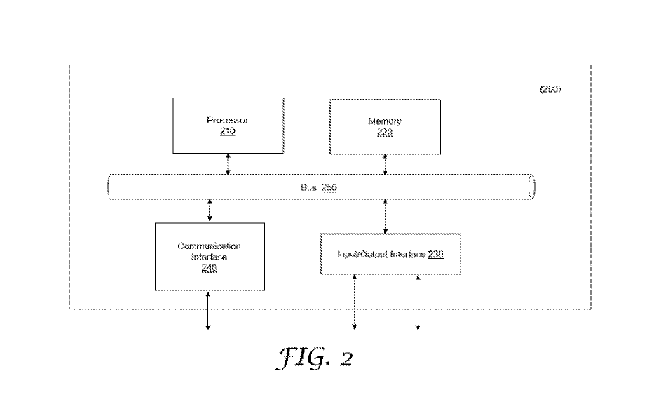

FIG. 2 illustrates an example of a mobile device 200 that includes a processor 210, a memory 220, an input/output interface 230, and a communication interface 240. A bus 250 provides a communication path between two or more of the components of mobile device 200. The components shown are provided by way of illustration and are not limiting. Mobile device 200 may have additional or fewer components, or multiple of the same component.

Processor 210 represents one or more of a general-purpose processor, digital signal processor, microprocessor, microcontroller, application specific integrated circuit (ASIC), field programmable gate array (FPGA), other circuitry effecting processor functionality, or a combination thereof, along with associated logic.

Memory 220 represents one or both of volatile and non-volatile memory for storing information (e.g., instructions and data). Examples of memory include semiconductor memory devices such as RAM, ROM, EPROM, EEPROM and flash memory devices, magnetic disks such as internal hard disks or removable disks, magneto-optical disks, CD-ROM and DVD-ROM disks, and the like. Memory 220 may further represent external memories, such as mass storage devices based on disks or solid state memory devices. Portions of system 100 may be implemented as computer-readable instructions in memory 220 of mobile device 200, executed by processor 210.

Input/output interface 230 represents electrical components and optional code that together provide an interface from the internal components of mobile device 200 to external components. Examples include a driver integrated circuit with associated programming.

Communications interface 240 represents electrical components and optional code that together provide an interface from the internal components of mobile device 200 to external networks, such as network 130.

Bus 250 represents one or more interfaces between components within mobile device 200. For example, bus 250 may include a dedicated connection between processor 210 and memory 220 as well as a shared connection between processor 210 and multiple other components of mobile device 200.

An embodiment of the disclosure relates to a non-transitory computer-readable storage medium (e.g., memory 220) having computer code thereon for performing various computer-implemented operations related to the techniques of the present disclosure. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (PLDs), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools.

Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions

FIG. 3 illustrates an example of contact information discovery and sharing device by way of a pseudo-flow block diagram according to an embodiment of the present invention. In this illustration, two mobile devices 310, 320 establish communication by dialing the contact number of one of the devices. A device enables a user to request contact information from the other device by using a mediating discovery server using the mobile number or the unique identifier of one of the devices.

In general, when User A dials contact number of another mobile device User B, initially a telecom connection is established (request 31, 31′) with the User B via network 330 and mediating server 340. Once telecom connection is detected, discovery server 340 determines the previous relatedness between the devices based on the stored communication log analysis and initiates a request (32, 32′, 33 and 33′) between the devices for contact information exchange.

In an embodiment User A, B devices send communication log details to the server 340 along with request for contact information of another device. It is an optional feature of present invention and limited to this embodiment only.

In another embodiment the User devices verify the log and then send the exchange request to the discovery server.

The discovery server 320 either on verification of the relatedness of the devices by looking at factors like miss calls, received calls, dialed calls, SMS exchanges, call length etc., automatically exchange the contact information between the User A, B devices or it prompts the second user B for authorization depending on the scenario and privacy settings. It may further initiate to second user B the option to get the first users A contact information.

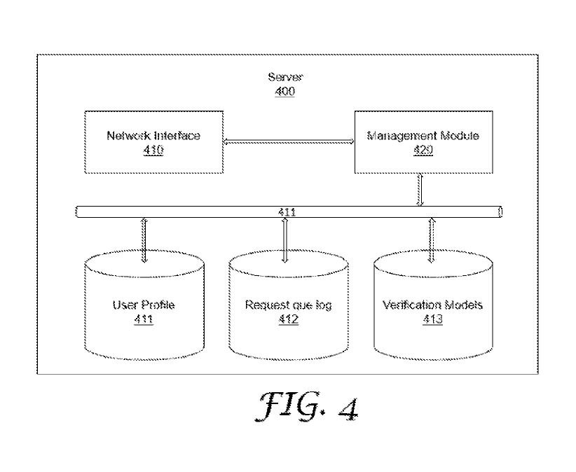

The discovery server does verification of user based on the received user identification and for each request for contact information exchange user identifier is search into the stored communication log in discovery server database. The database stores contact information associated with the plurality of mobile device users, communication log of each specific mobile device user and user profile in a structured format. More details about server database will be provided with respect to FIG. 4 in the specification.

Referring now to FIG. 4, it is a block diagram illustrating an exemplary architecture of the discovery server 400 in one embodiment. The server 400 includes a network interface 410, a user profile database 411, a user's request que log repository 412, a verification models database 413, and a management module 420. In a preferred embodiment of present invention a network interface (410) may be connected to internet.

The users request log repository 412 includes a nonvolatile memory for storing one or more request received form the user for exchanging information with an associated user. For example when a user A initiate a request for sharing information with user B, the user B is checked for valid registered user of the system and if user is not identified as registered user, the user A request for user B is queued in this memory, until user B registered as valid user of the system.

In general, the management module 420 manages the contact discovery and sharing services over the network interface 410. The management module 420 interacts with various databases, such as the user profile database 411, the repository of request log 412, and the verification models database 413, which store data structures corresponding to their respective data objects maintained at the discovery server 400. Depending upon the embodiment, the databases 411, 412 and 413 may be relational, flat, and/or other type of database. The databases 411, 412, 413 may be local to or remote from the discovery server 400. In alternative configurations of the discovery server, different or additional modules may be included in the server 400.

The user profile database 411 may store information about profile and their service details and preferences. A user may register with the system, which, in turn, creates a profile for the user within the system. The profile may include a user ID that uniquely identifies the user, a username and password to login to the system, phonebook, contact numbers and communication log associated with the user device. According to an embodiment of the present invention the user profile database may further include phonebook repository database storing phone numbers of the users within the system 200. Phonebook available from a repository 411, include contact's related information (e.g., First Name, Last name, mobile phone, home phone, office phone, email ID, work profile etc with the subscribers or called parties).

The verification log database 413 stores one or more verification models. These verification models are created based on the relatedness between the users communication logs. The communication log may store detailed information on all the incoming and outgoing phone calls, SMS, MMS, emails which can be queried by the management module 420. In one embodiment, a detailed communication log entry includes information of the user who initiate a call, contact number of called user (To: 123456789), e.g., called user B, contact number of caller (From: 02323232323). E.g. caller user A, such a mobile phone number, email ID, user ID, and other user identifiers. The Management module manages the user call communication log record as well as presentation and exchanging of contact information between the users during call or after the calls. When a call is detected, module 420 verifies authenticity of the user who initiates the call and upon verification analyses (Models) the relatedness between the called user and caller based on the information stored in communication log database at server. The server management module 420 determines relatedness between the users (caller/first user or called/second user) such as number of call made to a particular user, call length, SMS exchanged etc., and provides user selectable option on first user device for exchange contact information with second user. It may also automatically exchange contact information with the second user without any user intervention. If second user is not connected or registered user with the server 400 then the server may optionally send a message to the called user (second user) through other indirect channels or using simple SMS to onboard the second user. It may optionally give second user to simply provide the contact information without registering as a permanent user of the service. The verification log may be distributed across user devices or stored in a summarize manner to optimize the efficiency and establish the relatedness.

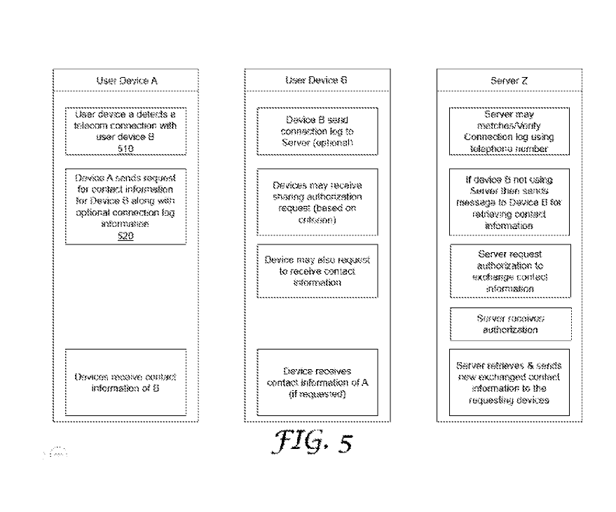

FIG. 5 illustrates process flow diagram illustrating an example of contact information sharing between user device A and B according to an embodiment of the present invention. The figure illustrates a server or possibly a cloud service serving many devices including mobile device A and B. They are all connected via the internet.

The mobile devices A and B are related to each other in terms of desire to connect with each other and thus wishing to exchange contact information. The server Z is a facilitator of contact exchange between the devices A, and B. When device A initiated communication (Telephonic/IP/sms/email), is detected by the server Z, device A is presented with an opportunity to confirm interest in exchanging contact information of Device B. The opportunity may be triggered by way of a previous relatedness between the users e.g., communication log history such as call log or SMS exchanged between the two devices, call length/common talk time. The Device A's request is then sent to Server. The server Z may then verify the authenticity of the request. Further the server Z will then determine a method to reach Device B to authorize such exchange of information. The contact information of the (users of) devices may be stored on the server or on the respected devices itself. The Device B may then either accept or deny such requests.

In an embodiment of the invention, It may preauthorize such exchange based on certain criterion like having a common talk time, SMS echange or pre-presence of Device A's information on device B etc. Device B may also explicitly or automatically request updated or new contact information of Device A from Server Z. The server Z may then retrieve the user contact information of the devices and provide it to the requesting mobile devices. In a preferred embedment the exchanged contact information is then updated in the native contacts book.

In one of the embodiments of the invention there may be pre-set privacy controls or multi-profile identity management.

In further detail, still referring to the invention of FIGS. 1 to 2 the internet or cloud is preferably a public internet. It may also be implemented using the telecom system or any other network.

The Server Z may be a single or multiple clustered servers. They may be virtual, physical, hosted or collocated in a data center or private premises. The server Z may be distributed or centralized. The data on the server Z may be distributed or centralized over multiple devices.

The requests of pairing two devices using call log or missed calls may be used to exchange other information as well. The user may be prompted for contact information update at the end of the call.

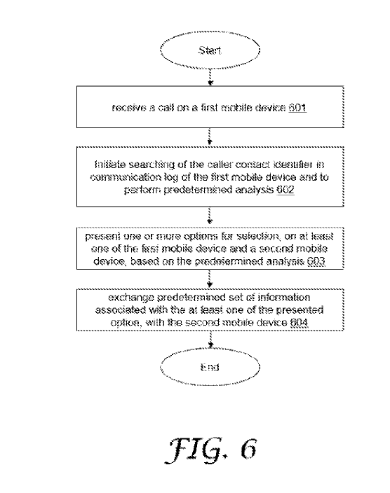

FIG. 6 illustrates flow chart method of contact information discovery between caller and recipient according to another embodiment of the present invention. The process start when mobile device detect telephone connection and receives an incoming call at step (601). Upon receiving the call from the caller at recipient device, the caller contact identifier associated with incoming call information is searched in the communication log and a predetermine analysis is performed simultaneously (at step 602). Based on the analysis recipient device is presented with user selectable options (at step 603) and based on the selected option a set of information is exchanged with the caller device (at step 604).

The invention may be coded in any computer language like java, android, IOS etc. by people having sufficient knowledge of client server architecture.

The invention may further be modified and used to further facilitate other services like payments or photo exchange by using stricter call log matching on both the devices.

The advantages of the present invention include, without limitation, easy pairing of two devices to exchange information such as user contact information without having to type the complete mobile numbers or needing to search the contact. The process helps people use device pairing especially in case of new mobile device or when contact books are lost.

The invention helps two devices to quickly network and exchange information. In broad embodiment, the present invention is a server providing easy method to exchange contacts between two mobile devices by initiating contact exchange using previous or active call or mobile logs.

In another embodiment of the invention communication between the servers may be encrypted communication.

All references of reader device may be assumed as mobile device interchangeably and includes scanner and other mobile devices, communication device etc. Further, terms like “device” and “system” are used interchangeably and synonymously throughout this document.

Obviously, numerous modifications and variations of the present disclosure are possible in light of the above teachings. It is therefore to be understood that within the scope of the appended claims, the disclosure may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such software may also be distributed in other forms, such as via the Internet or other wired or wireless telecommunication systems.

A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

I claim:

1. A contact information discovery method for automatically sharing contact information, comprising the steps of:
receiving a call on a first mobile device, wherein information associated with the call comprises a caller contact identifier;
initiating searching of the caller contact identifier in communication log of the first mobile device and to perform predetermined analysis;
presenting one or more options for selection, on at least one of the first mobile device and a second mobile device, based on the predetermined analysis; and
exchanging predetermined set of information associated with the at least one of the presented option, with the second mobile device.

2. The contact information discovery method of claim 1, wherein the call contact identifier comprises contact name, contact number and device identifier.

3. The contact information discovery method of claim 1, wherein the communication log comprises calls log history and SMS exchanged log.

4. The contact information discovery method of claim 3, wherein the calls log history comprises call details including incoming call, received calls and missed call to a user.

5. The contact information discovery method of claim 3, wherein the short service message (SMS) exchanged log details comprise number of SMS exchanges with a user.

6. The contact information discovery method of claim 1, wherein the exchanging information further involves sending a link to download a set of executable instructions to a second device to facilitate the exchange.

7. The contact information discovery method of claim 1, wherein the identification of the second device is added to a pending que till the second device executes a set of predetermined set of executable instructions for contact exchange.

8. The contact information discovery method of claim 1, wherein the predetermined analysis further comprising communication log analysis.

9. The contact information discovery method of claim 8, wherein the communication log analysis comprising relatedness of caller identifier with call/SMS log history at the first mobile device.

10. The contact information discovery method of claim 1, wherein the predetermined analysis further comprising authenticating caller based on pre-set identity management and privacy setting.

11. The contact information discovery method of claim 1, wherein the communication log further comprises number of calls, call length duration, number of SMS exchanged and user interaction pattern information.

12. A contact information discovery method for automatically sharing contact information, comprising the steps of:
receiving a call using a mobile network at a first mobile device, wherein information associated with the call comprises a caller contact identifier;
initiating searching of the caller contact identifier in a call log of first mobile device and performing predetermined call log analysis;
presenting one or more options for selection, on at least one of the first mobile device and a second mobile device, based on the call log analysis; and
transmitting predetermined set of the contact information associated with at least one of the presented option, using a mobile network to the second mobile device.

13. The contact information discovery method of claim 12, wherein the contact identifier comprises contact name, contact number and device identifier.

14. The contact information discovery method of claim 12, wherein the calls log comprises call details including incoming call, received calls and missed call to a user.

15. The contact information discovery method of claim 12, wherein the transmitting information further involves sending a link to download a set of executable instructions to a second device to facilitate the exchange.

16. The contact information discovery method of claim 12, wherein the identification of second device is added to a pending que till the second device executes a set of predetermined set of executable instructions for contact exchange.

17. The contact information discovery method of claim 12, wherein the predetermined call log analysis further comprising authenticating caller based on pre-set identity management and privacy setting.

18. The contact information discovery method of claim 12, wherein the predetermined call log analysis comprising relatedness of caller identifier with call/SMS log history at the first mobile device.

19. The contact information discovery method of claim 12, wherein call log comprises number of calls, call length duration, number of SMS exchanged and user interaction pattern information.

20. The contact information discovery method of claim 12, wherein predetermined call log analysis further comprising pre-authentication of a user based on common call length duration and pre-presence of first mobile device information on a second mobile device.

21. A machine readable medium carrying one or more sequences of instructions for execution by one or more processors in a device accessible by a network interface based on cellular telephony for enabling remote access to information stored on a first mobile device, wherein execution of said one or more sequences of instructions by said one or more processors causes said device to perform the actions of:
receiving an incoming call using a mobile network from first mobile device, wherein information associated the incoming call comprises a caller contact identifier;
initiating searching of the caller contact identifier in a calls log associated with a second mobile device and performing predetermined communication log analysis;
presenting one or more options for selection, on at least one of the first mobile device and a second mobile device, based on call log pattern analysis; and
transmitting predetermined set of the contact information associated with at least one of the presented option using the mobile network to the at least one of the first mobile device and second mobile device.
